(19) United States
(12) Patent Application Publication
(10) Pub. No.: US 2026/0099820 A1
(43) Pub. Date: Apr. 9, 2026

(54) METHOD AND SYSTEM FOR AUTOMATED HOST ALLOCATION

(71) Applicant: Honeywell International Inc., Charlotte, NC (US)

(72) Inventors: Anitha Eswari, Madurai (IN); Prabhu Kannan, Madurai (IN); Prabakar Kirupakaran, Madurai (IN)

(21) Appl. No.: 18/905,162

(22) Filed: Oct. 3, 2024

(51) Int. Cl. G06Q 10/1093; H04W 4/029

(52) U.S. Cl. CPC G06Q 10/1093; H04W 4/029

(57) ABSTRACT

A visitor management system and method for automated host allocation and room assignment using machine learning (ML) are disclosed. The system receives registration inputs from visitors and queries an access database to retrieve host information. If the designated host is unavailable, the system identifies alternative hosts based on predefined criteria such as department, hierarchy, and interaction frequency, and notifies the alternative hosts of the visitors. The system employs an ML model trained with historical data to optimize future host selections. Additionally, the system integrates with a Building Management System (BMS) to automatically allocate conference rooms based on visitor numbers and real-time room availability, ensuring efficient visitor management without manual intervention. The ML model continuously updates its preferences, refining the host, and room allocation processes over time.

### TECHNICAL FIELD

The present disclosure relates to visitor management systems. More particularly, the present disclosure relates to a method and system for automating host allocation and room assignments using machine learning (ML) techniques.

### BACKGROUND

Visitor management systems are widely used in various sectors such as corporate offices, hospitals, banks, and governmental institutions to manage and monitor visitor entries. These systems are often integrated with access control systems to track the real-time location of hosts within the premises. However, one common problem with existing systems arises when the designated host for a visitor is unavailable. In such cases, manual operator intervention is required to assign an alternative host, which can lead to significant delays and operational inefficiencies.

Moreover, identifying and allocating suitable conference rooms for visitors attending the same event is also done manually, further contributing to delays and poor resource management. These challenges are particularly detrimental in sectors such as healthcare and banking, where time is of the essence, and delays can have severe consequences on operations.

There is a need for an automated system that can dynamically assign alternative hosts and allocate suitable conference rooms based on the number of visitors and the real-time status of room availability. Such a system would not only enhance operational efficiency but also improve the visitor experience by reducing wait times.

### SUMMARY

The present disclosure relates to a method and system for automated host allocation and room assignment in a visitor management system, employing machine learning (ML) to eliminate the need for manual intervention when a designated host is unavailable. The system dynamically selects an alternative host based on historical data and predefined criteria such as department, hierarchy, and interaction frequency. Additionally, the system automatically identifies and allocates conference rooms based on the number of visitors arriving for the same occasion and real-time room availability.

In an embodiment, a method for automatically allocating one or more hosts for one or more visitors is provided. The method comprises receiving, at a visitor management system, a registration input from the one or more visitors, and querying an access database to retrieve information regarding one or more primary hosts associated with the one or more visitors. The method further comprises determining the presence of the one or more primary hosts within a premises by retrieving an access log of the one or more primary hosts, based on the retrieved host information. The method furthermore comprises selecting one or more secondary hosts based on predefined criteria, if the one or more primary hosts are not present in the premises determined by the access log, and notifying the presence of the one or more visitors to the selected one or more secondary hosts. Furthermore, the method comprises storing an identification of the selected one or more secondary hosts, and training a ML model using the registration input, the retrieved primary host information, and the stored secondary hosts' identification.

In some embodiments, receiving the registration input from the one or more visitors comprises receiving personal information regarding the one or more visitors.

In some embodiments, the method further comprising querying a building management system (BMS) to identify and select a conference room to accommodate the one or more visitors, verifying the selected conference room's availability by querying the access database linked to the BMS, and automatically selecting an alternative room if the initially selected conference room is occupied.

In some embodiments, the conference room is selected based on criteria including suitable room size, equipment availability, and proximity to the one or more visitors' location within the premises.

In some embodiments, the method further comprises prioritizing the conference room selection based on real-time occupancy data received from the BMS.

In some embodiments, the method further comprises notifying the one or more visitors and the allocated one or more primary hosts of the selected conference room via one or more communication channels including email, SMS, or a mobile application.

In some embodiments, the method further comprises automatically rescheduling the allocated conference room in response to changes in the number of the one or more visitors or room unavailability.

In some embodiments, the information regarding the one or more primary hosts used for querying the access database is an email ID associated with the one or more primary hosts.

In some embodiments, the one or more secondary hosts are selected based on the predefined criteria including previous interactions with the one or more primary hosts and/or the one or more visitors and hierarchy of the one or more secondary hosts in a department of the one or more primary hosts.

In some embodiments, the ML model is configured to automatically allocate the one or more primary hosts based on historical data and further configured to update the allocation of the one or more primary hosts' preferences based on patterns of host availability and visitor interactions.

In some embodiments, the visitor management system integrates with an access control system to track real-time location of the one or more primary hosts and the one or more secondary hosts within the premises.

In yet another embodiment, a visitor management system for automatically allocating one or more hosts for one or more visitors is disclosed. The system comprises a registration module, a host allocation module, a determining module, a selection module, a notification module, a storage module, and a training module. The registration module is configured to receive a registration input from the one or more visitors. The host allocation module is configured to query an access database to retrieve information regarding one or more primary hosts associated with the one or more visitors. The determining module is configured to determine, based on the retrieved host information, the presence of the one or more primary hosts within a premises by retrieving an access log of the one or more primary hosts. The selection module is configured to select one or more secondary hosts based on predefined criteria, if the one or more primary hosts are not present in the premises determined by the access log. The notification module is configured to notify the presence of the one or more visitors to the selected one or more secondary hosts. The storage module is configured to store an identification of the selected one or more secondary hosts, and the training module is configured to train a machine learning (ML) model using the registration input, the retrieved primary host information, and the stored secondary hosts' identification.

In some embodiments, the registration module is further configured to receive personal information regarding the one or more visitors.

In some embodiments, the host allocation module is further configured to query a building management system (BMS) to identify and select a conference room to accommodate the one or more visitors, verify the selected conference room's availability by querying the access database linked to the BMS, and automatically select an alternative room if the initially selected conference room is occupied.

In some embodiments, the conference room is selected based on criteria including suitable room size, equipment availability, and proximity to the one or more visitors' location within the premises.

In some embodiments, the information regarding the one or more primary hosts used for querying the access database is an email ID associated with the one or more primary hosts.

In some embodiments, the selection module is further configured to select the one or more secondary hosts based on the predefined criteria including previous interactions with the one or more primary hosts and/or the one or more visitors and hierarchy of the one or more secondary hosts in a department of the one or more primary hosts.

In some embodiments, the ML model is configured to automatically allocate the one or more primary hosts based on historical data and further configured to update the allocation of the one or more primary hosts' preferences based on patterns of host availability and visitor interactions.

In some embodiments, the visitor management system integrates with an access control system to track real-time location of the one or more primary hosts and the one or more secondary hosts within the premises.

In yet another embodiment, a non-transitory computer-readable medium is disclosed, having stored thereon computer-readable instructions that, when executed by a processor, cause the processor to execute a method for automatically allocating one or more hosts for one or more visitors, comprising receiving, at a visitor management system, a registration input from the one or more visitors. The computer-readable instructions further cause the processor to query an access database to retrieve information regarding one or more primary hosts associated with the one or more visitors; based on the retrieved host information, determine the presence of the one or more primary hosts within a premises by retrieving an access log of the one or more primary hosts; select one or more secondary hosts based on predefined criteria, if the one or more primary hosts are not present in the premises determined by the access log; notify the presence of the one or more visitors to the selected one or more secondary hosts; store an identification of the selected one or more secondary hosts; and train a machine learning (ML) model using the registration input, the retrieved primary host information, and the stored secondary hosts' identification.

The disclosure addresses the inefficiencies in existing systems by eliminating manual intervention when the designated host is unavailable and streamlining room assignments based on visitor numbers and real-time room availability.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1(a)-(b) illustrates a block diagram illustrating an architecture of an automated host allocation system within a visitor management framework, depicting the process of automated host allocation and room allocation according to an embodiment of the disclosure;

FIG. 2 illustrates a flowchart depicting the process of automated host allocation according to an embodiment of the disclosure;

FIG. 3 illustrates a system for automated host allocation according to an embodiment of the disclosure; and

FIG. 4 illustrates a schematic diagram of another communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

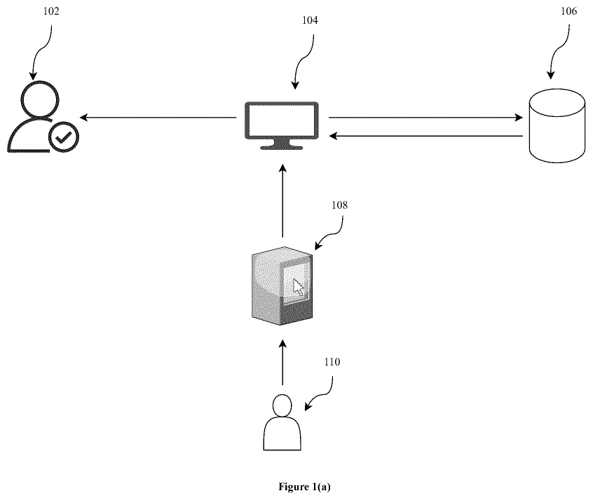

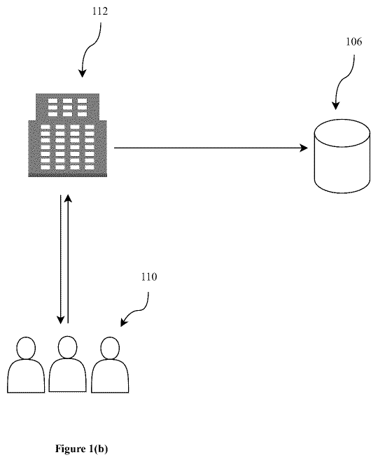

FIG. 1(a)-(b) illustrates a system architecture of a visitor management system 104, which features automated host allocation in FIG. 1(a) and room assignment using machine learning (ML) in FIG. 1(b). The visitor management system 104 streamlines visitor check-ins and optimizes the assignment of an available host when the primary host is unavailable. The visitor management system 104 also automates the allocation of conference rooms based on visitor count and room availability. A detailed description of the system 104's components and flow, including various embodiments is provided below.

FIG. 1(a) shows the visitor management system 104 connected to an access database 106 and a Kiosk 108. The access database 106 manages information about both visitors 110 and hosts. In some embodiments, the database 106 can refer to a variety of structured data repositories, including relational databases, cloud-based storage solutions, or even decentralized databases. Additionally, a visitor 110 arriving at the premises is depicted in FIG. 1(a). In various embodiments, the term premises can refer to a variety of environments including but not limited to corporate offices, government buildings, educational institutions, healthcare facilities, or residential complexes.

Upon arrival, the visitor 110 inputs registration details such as name, visit purpose, and the intended host, through interfaces like the kiosk 108, mobile app, or web platform. For instance, a visitor 110 named John registers at a corporate office using the kiosk 108, providing the email of his host, Jane.

In another embodiment, the visitor management system 104 facilitates the registration process through the mobile app and the web platform interfaces. Also, Visitors can pre-register their details remotely before arriving at the premises, which significantly reduces wait times and improves the overall check-in experience. For instance, a visitor 110 named John receives an invitation from his host, Jane, via email, which includes a link to the visitor management system's web platform or a prompt to download the mobile app.

Upon accessing the web platform or mobile app, John inputs his registration details, such as his name, visit purpose, and Jane's email address. Additionally, the mobile app can leverage features like camera-based QR code scanning or NFC (Near Field Communication) to expedite data entry. Once the registration details are submitted, the system 104 pre-populates John's information in the kiosk 108 or other entry systems, allowing him to proceed directly to check-in upon arrival at the premises.

In various embodiments, the mobile app and web platform may offer additional functionality, such as real-time notifications regarding host availability, directions to the meeting room, or virtual passes for accessing specific areas within the premises. Furthermore, both interfaces can support secure authentication methods, including multi-factor authentication (MFA) or biometric verification, ensuring the visitor's identity is confirmed prior to granting access.

This embodiment improves efficiency and enhances user convenience by allowing visitors to complete the registration process at their convenience, even before stepping onto the premises.

Further, the kiosk 108 transmits the visitor's registration details to the visitor management system 104, which then queries the access database 106 to retrieve host information related to the visitor.

In one embodiment, the transmission of the visitor's registration details from the kiosk 108, mobile app, or web platform to the visitor management system 104 is facilitated through secure communication protocols. The data is transmitted over an encrypted channel, such as HTTPS, ensuring the confidentiality and integrity of the visitor's personal information during transit. In some embodiments, advanced security measures, including Transport Layer Security (TLS) may be implemented to prevent unauthorized access or tampering with the data.

Once the visitor's registration details are received by the visitor management system 104, the system 104 initiates a query to the access database 106 to retrieve the relevant host information. This query is executed using structured query language (SQL) in embodiments where relational databases are employed. In other embodiments, particularly those using cloud-based or decentralized storage, the system 104 may use APIs (Application Programming Interfaces) or a distributed query engine to interact with the access database 106.

The query may include parameters such as the host's email address, name, or department, which are extracted from the visitor's registration input. Upon receiving the query, the access database 106 returns a response containing relevant host data, such as the host's access history, current location within the premises, or availability status.

In certain embodiments, the communication between the visitor management system 104 and the access database 106 occurs asynchronously using message queues or event-driven architecture. This approach allows the system 104 to handle multiple concurrent queries without delays, ensuring a smooth visitor check-in experience. For instance, as soon as the visitor John registers with Jane's email address, the system 104 immediately queries the database 106, retrieves Jane's details, and prepares to assign a secondary host if necessary.

In an embodiment, using the retrieved host information and the registration details, the visitor management system 104 checks the presence of the designated hosts by retrieving access logs from the access database 106. In one embodiment, the query to the database 106 is based on the host's email ID.

The access database 106 also stores host-related data, including previous access logs and criteria for selecting alternate hosts. The visitor management system 104 uses this data to identify colleagues or alternative hosts 102 when the primary host is unavailable. These alternative hosts 102 may also be referred to as secondary hosts 102 in various embodiments. In the example, the database 106 contains Jane's details, such as her email, access card number, and a list of colleagues who can act as substitutes. Continuing with the example, if Jane is absent when John arrives, the system 104 queries her access log and selects a colleague, David, as the alternative host based on predefined criteria. These criteria can include previous interactions with the visitor 110 or host and the hierarchy within the department.

Once the secondary host is selected, the system 104 notifies the secondary host of the visitor's presence and stores their identification. Additionally, the system 104 uses the visitor's registration input, the primary host's information, and the secondary host data to train a machine learning (ML) model for future room assignment and host selection processes.

FIG. 1(b) illustrates the process and system architecture for conference room allocation within a facility, based on visitor arrival data. The system involves communication between a building management system (BMS) 112, the access database 106, and visitors' 110 who are arriving for a meeting or event. The system leverages automation to dynamically allocate appropriate conference rooms based on real-time visitor data, thus optimizing room usage and ensuring a seamless experience for both hosts and visitors 110.

The visitors 110 represents the visitors who arrive at the facility for an event or a meeting. The number of visitors is counted, and their details are entered into the visitor management system, which is not shown in this specific figure, but plays a critical role.

According to an exemplary embodiment, a group of 5 visitors arrive for a board meeting and the visitor management system registers their information as they check in. The BMS 112 is responsible for managing the allocation of rooms within the building. Upon receiving input from the visitor management system about the number of visitors, the BMS 112 identifies suitable conference rooms based on capacity and availability.

The BMS 112 manages and optimizes the usage of conference rooms by ensuring that no room is overbooked or underutilized. According to the exemplary embodiment discussed above, if a group of 5 visitors is attending a meeting, the BMS 112 may allocate a room with a seating capacity of 8 people. However, if the number of visitors exceeds room capacity, the system will automatically select another room to accommodate the larger group.

The access database 106 is queried by the BMS 112 to check the availability of conference rooms. It holds historical data regarding room occupancy, room bookings, and prior visitor events. When the BMS 112 queries the database 106, it verifies which rooms are available for the visitors 110 based on current usage and schedules. According to an embodiment, if conference room 1 is currently booked for another event, the database 106 will reflect this status, and the BMS 112 will choose an alternate room.

Upon visitor 110 arrival, the visitor management system identifies the visitor group size and communicates this data to the BMS 112. The BMS 112 checks the access database 106 for room availability and selects an appropriate room based on the visitor count. The room assignment is communicated back to the visitor management system for notifying the visitors 110 and guiding them to the assigned room.

According to another embodiment, a group of 20 visitors arrives for a large meeting. The visitor management system detects the group size and sends the information to the BMS 112, which allocates a larger room, such as conference room 4, capable of seating 25 people. Once the room is confirmed, the visitors are directed to it automatically.

The visitor management system is a critical backend component that captures visitor data, including the number of attendees for a specific event or meeting. This data is then forwarded to the BMS 112 for room allocation. The BMS 112 communicates with the access database 106 to ensure that room allocation is based on real-time availability. This system prevents any room from being double-booked and ensures the appropriate room size is selected based on visitor count.

The primary host is not explicitly shown in this figure but is a part of the overarching system. The host's details and any preferences for room allocation are likely stored in the access database 106.

In this embodiment, the visitor management system 104 automatically detects the number of visitors who have arrived and then communicates this information to the BMS 112. The BMS 112 queries the access database 106 for room availability and ensures that a suitable room is allocated. For example, for an event with 50 visitors, the BMS 112 allocates a large conference hall and once this allocation is confirmed, the visitor group 110 receives a notification with room details.

In some cases, the visitor count may change dynamically (e.g., if additional attendees arrive late). The system can accommodate this by reallocating rooms as needed. For example, initially, 10 visitors arrive and are allocated conference room 3, but as 15 more people arrive later, the BMS 112 reallocates the group to conference room 6, which has a larger capacity.

Some rooms may be reserved for high-priority meetings or events. In this case, the system can be configured to prioritize certain rooms for specific hosts or visitor groups 110.

As an exemplary embodiment, a VIP group is expected to arrive for a meeting. The system ensures that conference room 1, reserved for high-profile meetings, remains available for this group.

Advanced embodiments may employ machine learning algorithms to predict the optimal room allocation based on historical data of visitor arrivals, room preferences, and occupancy patterns. The system learns from past events and suggests the best room allocation based on expected visitor numbers. For example, over time, the system learns that board meetings typically have 25 attendees and suggests the allocation of conference room 5 whenever a similar event is scheduled in the future.

In one exemplary embodiment, a corporation uses this automated system to manage its conference rooms. A group of 15 visitors arrives for a presentation. Upon their arrival, the visitor management system identifies the number of attendees and communicates with the BMS 112 to find an appropriate room. The BMS 112 checks the access database 106 and identifies that conference room 2 is available with a seating capacity of 20, making it the ideal choice. The BMS 112 assigns the room and sends the details back to the visitor management system, which then notifies both the host and the visitors of the room assignment.

This process occurs seamlessly, minimizing the need for manual intervention and ensuring that rooms are allocated efficiently. The system also provides flexibility for reallocation in case the number of visitors increases or decreases, optimizing room usage across the facility. By integrating room allocation with real-time visitor data and building management systems, the invention enhances operational efficiency and improves the visitor experience.

According to an embodiment, the visitor management system 104 incorporates a machine learning (ML) model to continuously improve the efficiency of room assignments and host selection. This ML model is trained using a variety of input data collected during the visitor check-in and host allocation processes. Key data used for training the model includes: visitor's registration input, primary host's information, and secondary host data. The visitor's registration input includes information such as the visitor's name, visit purpose, and the intended host's details (e.g., email address or department). The primary host's information includes data related to the primary host, including their access logs, availability, department hierarchy, and previous interactions with the visitor 110 or similar visitors. The secondary host data includes information about secondary hosts, including their role, proximity to the primary host, previous experiences acting as substitute hosts, and hierarchy within the organization.

This data is collected and labeled, forming a training dataset that is used to improve the ML model's predictions. For example, the system can learn patterns based on how frequently certain secondary hosts are selected in place of primary hosts, the success of those interactions, and the efficiency of the room allocation process. The system can also analyze visitor behaviors, such as recurring visits by the same individual, and use that information to refine future host and room assignments.

The ML model undergoes supervised learning, where historical data from previous visitor interactions and room assignments is used as training input. The system uses various algorithms such as decision trees, random forests, or neural networks to recognize patterns and make predictions. These predictions are based on factors like: host availability, host substitution criteria, room assignment optimization, and feedback loop and continuous improvement. For host availability, the system predicts whether a primary host will be available at the time of the visit based on past data. For host substitution criteria, the ML model ranks potential secondary hosts based on predefined criteria such as department, hierarchy, and previous visitor interactions.

For room assignment optimization, the model also learns the optimal room assignment based on the number of visitors, room availability, and the nature of the visit (e.g., conference meeting, interview, etc.). For feedback loop and continuous improvement, each time a new visitor registration occurs, the system collects additional data on the success of the host assignment and room allocation. For instance, after a visitor 110 is paired with a secondary host or assigned a room, feedback on how smoothly the process went is recorded. This feedback loop allows the ML model to continually refine its predictions and improve its accuracy over time.

In an exemplary embodiment, consider a scenario where John regularly visits a corporate office to meet with his primary host, Jane. Over several visits, it becomes apparent that Jane is frequently unavailable due to her travel schedule. The ML model, using historical data, learns that David, a colleague of Jane, is often selected as an alternative host when Jane is unavailable. As a result, during John's future visits, the system predicts that David should be the preferred secondary host and assigns him without delay.

Similarly, if John's visits often involve meetings with multiple participants, the ML model learns that larger conference rooms are typically required for these visits. Over time, the model becomes more efficient in selecting appropriately sized rooms, minimizing the need for last-minute room changes or reassignment.

By continually learning from visitor patterns, host availability, and room usage, the ML model enhances the overall efficiency of the visitor management system, leading to faster check-ins and improved visitor experiences.

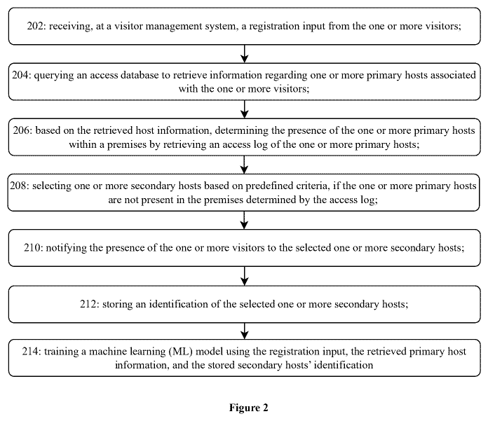

FIG. 2 illustrates a flowchart depicting the process of automated host allocation based on visitor registration input according to an embodiment of the disclosure. Specifically, the method discloses automatically allocating one or more hosts for one or more visitors.

At step 202, the method begins with receiving a visitor's registration input at the visitor management system 104. This registration input includes personal information, such as the visitor's name, visit purpose, and the intended host's email or contact information. Once the input is received, the system queries the access database 106 at step 204 to retrieve information regarding the one or more primary hosts associated with the visitor.

For instance, a visitor named John provides his details and the email address of his primary host, Jane, via the kiosk 108 or mobile app. The system queries the access database 106 to retrieve Jane's information, such as her department and recent access log entries.

At step 206, the system determines whether the primary host is present within the premises. It does this by querying the access control system, retrieving recent access logs of the primary host. If the primary host is unavailable (i.e., no recent access log entry or absence is confirmed), the system moves to step 208, where it selects a secondary host based on predefined criteria.

In continuation of the aforementioned example, the system identifies that Jane hasn't checked in to the building recently, triggering the selection of a secondary host. David, a colleague of Jane, is selected based on predefined criteria such as his role, department proximity, and prior interactions with John.

At step 210, the visitor management system notifies the selected secondary host of the visitor's presence. Following this, at step 212, the system stores the identification details of the selected secondary host in the database 106 for future reference. Additionally, at step 214, the system uses this data (visitor registration input, primary host information, and secondary host details) to train a machine learning (ML) model for future optimization of host selection and room assignments.

After David is selected as John's secondary host, the system sends David a notification (via email or mobile app) informing him of John's arrival. This interaction is stored, and the ML model learns from it, enabling future predictions for when John visits again.

In an embodiment, the ML model is configured to automatically allocate primary or secondary hosts based on historical data. It continually updates host allocation preferences by identifying patterns of host availability and visitor interactions. For example, if Jane is frequently unavailable and David is often selected, the ML model might prioritize David as a secondary host for John in future visits.

According to an embodiment, the method further involves querying a building management system (BMS) 112 to identify and allocate a conference room for the visitor. The system verifies the availability of the selected conference room by querying the BMS 112 through the access database 106. If the selected room is occupied, the system automatically selects an alternative room.

For instance, after David is assigned as John's host, the system checks the availability of a conference room for their meeting. It selects a suitable room based on criteria such as the number of visitors, required equipment, and proximity. If the room is occupied, the system assigns another available room.

The selected conference room is based on several criteria, including room size, equipment availability, and proximity to the visitor's location. In some embodiments, the system prioritizes room selection based on real-time occupancy data from the BMS 112 and notifies the visitor and host of the room assignment via multiple communication channels such as email, SMS, or the mobile app.

John receives a notification on his phone about the conference room assigned for his meeting with David. The room has the required projector and seating capacity based on John's visitor profile.

In another embodiment, the system can automatically reschedule the conference room allocation if there are changes to the number of visitors or room availability. For example, if additional visitors are added or the room becomes unavailable, the system promptly reallocates another suitable room and notifies all parties involved.

The selection of secondary hosts is based on predefined criteria such as prior interactions between the visitor and the primary or secondary host, and the hierarchical position of the secondary host within the department of the primary host.

In a scenario where Jane is unavailable, the system might prioritize David as the secondary host based on the fact that he has previously interacted with John and holds a relevant position within Jane's department.

According to another embodiment, the visitor management system integrates with an access control system to track the real-time location of both the primary and secondary hosts within the premises. This real-time tracking ensures accurate and timely host allocation decisions, allowing the system to adapt quickly to changes in host availability.

The system monitors Jane and David's movements within the premises. If David leaves the building, the system may automatically assign another colleague as a secondary host for John in real time, ensuring that John is always greeted by an available host.

The method illustrated in FIG. 2, which details the automated host allocation process based on visitor registration input, presents a series of technical advancements that contribute to an improved visitor management system. The technical effect of this method can be summarized as follows efficient host allocation, dynamic and intelligent host selection, real-time room allocation, scalability and flexibility, seamless communication and notifications, improved resource utilization, enhanced security and privacy, and user experience optimization.

Regarding efficient host allocation, the system automates the allocation of primary and secondary hosts based on visitor registration input, host availability, and predefined criteria. This process eliminates the need for manual host assignment, ensuring that visitors are promptly attended to, even if the primary host is unavailable. The querying of the access database 106 to retrieve host information and access logs in real time ensures that host assignment decisions are both timely and accurate.

For dynamic and intelligent host selection, machine learning (ML) algorithms is incorporated, the system continually learns from previous visitor interactions and host availability patterns. This enables the system to intelligently predict host preferences and optimize future host assignments. The ML model's training on historical data allows it to enhance the decision-making process, leading to more efficient and context-aware host selection over time.

The system's integration with a building management system (BMS) 112 facilitates real-time conference room allocation. The ability to query the BMS 112 for room availability and automatically assign or reassign rooms based on current occupancy ensures that visitors and hosts are always provided with appropriate and available meeting spaces. This reduces the likelihood of double bookings or room conflicts and enhances the overall visitor experience.

The system is designed to handle a wide range of visitor-host interactions from small meetings to large events requiring multiple hosts and rooms. The predefined criteria for selecting secondary hosts and the dynamic room allocation system ensure that the method can scale efficiently, accommodating varying numbers of visitors and hosts while maintaining smooth operations.

The system not only automates host and room assignment but also ensures that all relevant parties (visitors, primary hosts, secondary hosts) are promptly notified through multiple communication channels, such as email, SMS, or mobile apps. This real-time notification system improves coordination between visitors and hosts, reducing delays and enhancing overall visitor satisfaction.

By leveraging the real-time data from the access database 106 and BMS 112, the system optimizes resource utilization, both in terms of host allocation and room assignment. The automated selection of secondary hosts based on availability and relevance, along with the dynamic room reallocation based on changing circumstances, ensures that organizational resources are used efficiently and effectively.

The use of secure communication protocols for transmitting registration inputs, along with the controlled access to the access database 106, ensures that sensitive visitor and host information is handled with high security standards. The system's ability to integrate with access control systems adds an additional layer of security by tracking host presence and ensuring that only authorized personnel are assigned as hosts.

The combination of automated host selection, intelligent ML-based predictions, dynamic room allocation, and seamless real-time notifications contributes to an optimized and frictionless user experience. Visitors are guided through the check-in process efficiently, hosts are informed and prepared in advance, and room availability is managed seamlessly, creating a streamlined visitor management system.

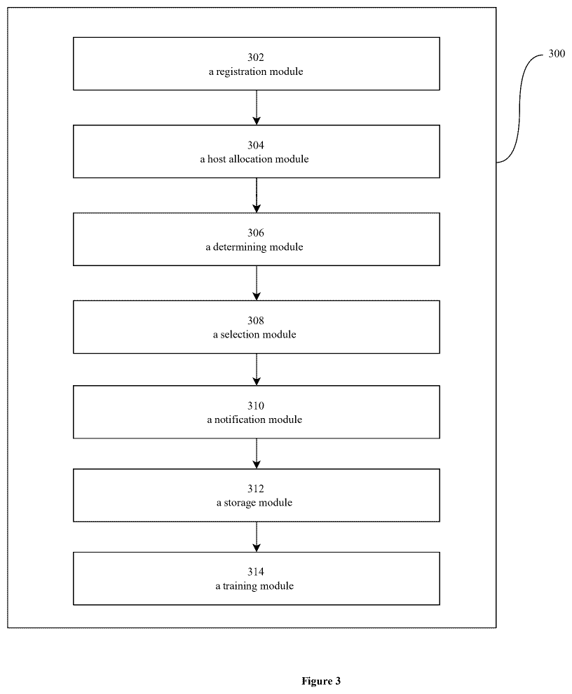

FIG. 3 illustrates a system for automated host allocation according to an embodiment of the disclosure. The system 300 comprises various modules, including a registration module 302, a host allocation module 304, a determining module 306, a selection module 308, a notification module 310, a storage module 312, and a training module 314. Each module plays a critical role in ensuring the seamless operation of the visitor management system 104.

The registration module 302 is designed to receive registration details from visitors. These details typically include personal information, such as the visitor's name, the purpose of the visit, and the intended host. For example, when a visitor named John arrives at a corporate office, he enters his details, such as his name and the email of his host, Jane. The registration module processes this information, acting as the first point of interaction between the visitor and the system.

In another embodiment, the visitor management system 104 streamlines the registration process by offering the mobile app and web platform interfaces. Visitors can pre-register their details remotely before arriving on-site, reducing wait times and enhancing the check-in experience. For instance, John, the visitor, may receive an invitation email from his host, Jane, which contains a link to the system's web platform or a prompt to download the mobile app.

Upon accessing the web platform or mobile app, John inputs his registration information, including his name, the purpose of his visit, and Jane's email address. The mobile app may also feature options like QR code scanning via the device's camera or NFC (Near Field Communication) to speed up data entry. Once submitted, John's details are pre-loaded into the kiosk 108 or other entry systems, allowing him to proceed quickly with check-in upon arrival.

In some embodiments, the mobile app and web platform offer additional functionality, such as real-time updates on host availability, directions to the meeting room, or virtual passes for accessing restricted areas within the premises. Both interfaces support secure authentication options, including multi-factor authentication (MFA) and biometric verification, to confirm the visitor's identity before access is granted.

In one embodiment, the visitor's registration details entered via the kiosk 108, mobile app, or web platform are securely transmitted to the visitor management system 104 using encrypted communication protocols. The data is sent over a secure channel, such as HTTPS, to ensure the confidentiality and integrity of the visitor's personal information during transmission. In some cases, additional security measures, such as Transport Layer Security (TLS), may be employed to prevent unauthorized access or tampering with the data.

Once the visitor management system 104 receives the registration details, it initiates a query to the access database 106 to retrieve relevant host information. This query is typically performed using Structured Query Language (SQL) in cases where relational databases are utilized. In other embodiments, particularly those using cloud-based or decentralized storage systems, the system 104 may interact with the access database 106 through APIs (Application Programming Interfaces) or a distributed query engine.

The query parameters, such as the host's email address, name, or department, are extracted from the visitor's registration input. The access database 106 processes the query and returns relevant host data, which may include the host's access history, current location within the premises, or their availability status.

In certain embodiments, communication between the visitor management system 104 and the access database 106 is managed asynchronously using message queues or an event-driven architecture. This method allows the system to handle multiple simultaneous queries efficiently, minimizing delays, and ensuring a smooth check-in process. For example, once John registers with Jane's email address, the system 104 instantly queries the database 106, retrieves Jane's information, and, if needed, prepares to assign an alternative host.

This embodiment enhances both efficiency and convenience by enabling visitors to complete the registration process in advance, even before arriving at the premises.

Once the registration input is received, the host allocation module 304 queries an access database 106 to retrieve information regarding the primary host, such as the host's email ID, past interaction history, or other identifiers. The access database 106 manages information about both visitors 110 and hosts. In some embodiments, the database 106 can refer to a variety of structured data repositories, including relational databases, cloud-based storage solutions, or even decentralized databases. For instance, the system retrieves Jane's profile, including her contact details and department information, from the access database 106. This allows the system to determine whether Jane is available to meet the visitor.

The determining module 306 plays a pivotal role in identifying the host's presence within the premises. In various embodiments, the term premises can refer to a variety of environments, including but not limited to corporate offices, government buildings, educational institutions, healthcare facilities, or residential complexes. It retrieves real-time access logs from the access control system (ACS) or database 106 to ascertain whether Jane has entered the building. If the access log indicates that Jane is absent, the system proceeds to the next step.

If the primary host is unavailable, the selection module 308 automatically selects an alternative or secondary host based on predefined criteria, such as department hierarchy, proximity to the visitor's location, or frequency of previous interactions with the visitor. For example, if Jane is absent, the system may select her colleague David, who works in the same department, based on the fact that David has interacted with the visitor or shares a similar role as Jane.

Once the alternative host is identified, the notification module 310 sends alerts to both the selected host and the visitor, informing them of the host reassignment. For instance, David receives an SMS or email notifying him that he has been assigned as John's host, while John receives a message with the details of the change. This real-time communication ensures that both parties are promptly informed, preventing any delays or confusion.

In parallel, the storage module 312 stores the identification of the selected secondary host, ensuring that the data is available for future reference. This stored data can be used to refine future host assignments based on historical records.

One of the key innovations in the system is the integration of machine learning (ML). The training module 314 is configured to train an ML model using the data collected from the registration input, primary host information, and the stored secondary host identification. Over time, this ML model improves its ability to predict the most suitable alternative host based on patterns of host availability and visitor-host interactions. For example, if David frequently substitutes for Jane when she is absent, the system will prioritize David in future scenarios, optimizing the overall host allocation process.

According to another embodiment, the host allocation module 304 is also configured to query a building management system (BMS) 112 to identify and select an appropriate conference room for the meeting. The BMS 112 checks the real-time occupancy of available rooms and selects one that meets the visitor's requirements, such as room size and equipment availability. For instance, if room 101 is already occupied, the BMS 112 automatically assigns room 103, ensuring that the visitor has access to a suitable meeting space without manual intervention.

The BMS 112 not only manages room availability but also tracks occupancy levels to ensure that the assigned room can accommodate the number of visitors. For example, if John's meeting involves five attendees, the BMS 112 allocates a room with the required capacity. If the situation changes, such as a sudden increase in the number of visitors or the unavailability of the initially assigned room, the system dynamically reallocates an alternative room in real time.

The alternative host (secondary host) is a designated colleague of the primary host and is selected based on predefined criteria stored in the access database 106. For example, if Jane is unavailable to meet John, David, a colleague from the same department and hierarchy level, is selected as the alternative host. This predefined selection ensures that the host is not only available but also qualified to handle the visitor's needs. David, for instance, may have prior interactions with John, making him a logical substitute for Jane.

After the system selects the secondary host, notifications are sent to both the visitor and the host through multiple communication channels, such as email, SMS, or mobile app notifications. For example, David receives an SMS notifying him of his reassignment as John's host, while John receives an email with details about the new host and the allocated meeting room.

The machine learning model continuously learns from the data it processes, such as visitor-host interactions, host availability, and room occupancy trends. Over time, the model becomes more efficient at predicting which alternative host to select and which rooms are likely to be available. For example, if Jane frequently delegates her hosting duties to David, the system will start prioritizing David in future assignments whenever Jane is unavailable, streamlining the entire process.

This system significantly enhances the efficiency of visitor management by automating host and room allocation, reducing the need for manual intervention. The combination of real-time data analysis, machine learning, and seamless communication channels provides a smooth and professional experience for both visitors and hosts.

The system described is applicable across a wide range of industries, including corporate offices, healthcare facilities, and educational institutions, where efficient visitor management is critical. It not only improves operational efficiency but also ensures a positive visitor experience by minimizing wait times and ensuring that meetings occur smoothly, even when the primary host is unavailable.

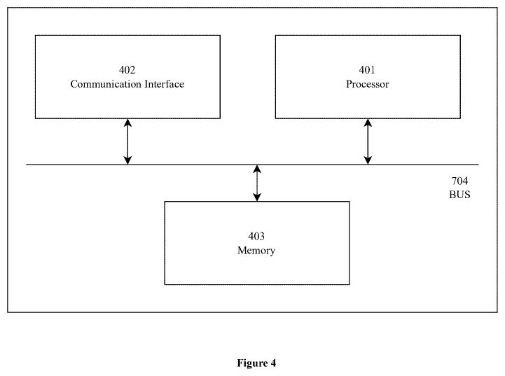

FIG. 4 illustrates a schematic diagram of another communication apparatus 400 according to an embodiment of the disclosure. The communication apparatus 400 includes a processor 401, a communication interface 402, and a memory 403. The processor 401, the communication interface 402, and the memory 403 may be connected to each other via a bus 404. The bus 404 may be a peripheral component interconnect (peripheral component interconnect, PCI) bus, an extended industry standard architecture (extended industry standard architecture, EISA) bus, or the like. The bus 404 may be classified into an address bus, a data bus, a control bus, and the like. For ease of representation, the bus is represented by using only one line in FIG. 4, but it does not indicate that there is only one bus or one type of bus. The processor 401 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 403 may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method for automatically allocating one or more hosts for one or more visitors, comprising the steps of:
receiving, at a visitor management system, a registration input from the one or more visitors;
querying an access database to retrieve information regarding one or more primary hosts associated with the one or more visitors;
based on the retrieved host information, determining the presence of the one or more primary hosts within a premises by retrieving an access log of the one or more primary hosts;
selecting one or more secondary hosts based on predefined criteria, if the one or more primary hosts are not present in the premises determined by the access log;
notifying the presence of the one or more visitors to the selected one or more secondary hosts;
storing an identification of the selected one or more secondary hosts; and
training a machine learning (ML) model using the registration input, the retrieved primary host information, and the stored secondary hosts' identification.

2. The method as claimed in claim 1, wherein receiving the registration input from the one or more visitors comprises receiving personal information regarding the one or more visitors.

3. The method as claimed in claim 1, further comprising:
querying a building management system (BMS) to identify and select a conference room to accommodate the one or more visitors;
verifying the selected conference room's availability by querying the access database linked to the BMS; and
automatically selecting an alternative room if the initially selected conference room is occupied.

4. The method as claimed in claim 3, wherein the conference room is selected based on criteria including suitable room size, equipment availability, and proximity to the one or more visitors' location within the premises.

5. The method as claimed in claim 3, further comprising prioritizing the conference room selection based on real-time occupancy data received from the BMS.

6. The method as claimed in claim 3, further comprising notifying the one or more visitors and the allocated one or more primary hosts of the selected conference room via one or more communication channels including email, SMS, or a mobile application.

7. The method as claimed in claim 3, further comprising automatically rescheduling the allocated conference room in response to changes in the number of the one or more visitors or room unavailability.

8. The method as claimed in claim 1, wherein the information regarding the one or more primary hosts used for querying the access database is an email ID associated with the one or more primary hosts.

9. The method as claimed in claim 1, wherein the one or more secondary hosts are selected based on the predefined criteria including previous interactions with the one or more primary hosts and/or the one or more visitors and hierarchy of the one or more secondary hosts in a department of the one or more primary hosts.

10. The method as claimed in claim 1, wherein the ML model is configured to automatically allocate the one or more primary hosts based on historical data and further configured to update the allocation of the one or more primary hosts' preferences based on patterns of host availability and visitor interactions.

11. The method as claimed in claim 1, wherein the visitor management system integrates with an access control system to track real-time location of the one or more primary hosts and the one or more secondary hosts within the premises.

12. A visitor management system for automatically allocating one or more hosts for one or more visitors, comprising:
a registration module configured to receive a registration input from the one or more visitors;
a host allocation module configured to query an access database to retrieve information regarding one or more primary hosts associated with the one or more visitors;
a determining module configured to determine, based on the retrieved host information, the presence of the one or more primary hosts within a premises by retrieving an access log of the one or more primary hosts;
a selection module configured to select one or more secondary hosts based on predefined criteria, if the one or more primary hosts are not present in the premises determined by the access log;
a notification module configured to notify the presence of the one or more visitors to the selected one or more secondary hosts;
a storage module configured to store an identification of the selected one or more secondary hosts; and
a training module configured to train a machine learning (ML) model using the registration input, the retrieved primary host information, and the stored secondary hosts' identification.

13. The system as claimed in claim 12, wherein the registration module is further configured to:
receive personal information regarding the one or more visitors.

14. The system as claimed in claim 12, wherein the host allocation module is further configured to:
query a building management system (BMS) to identify and select a conference room to accommodate the one or more visitors;
verify the selected conference room's availability by querying the access database linked to the BMS; and
automatically select an alternative room if the initially selected conference room is occupied.

15. The system as claimed in claim 14, wherein the conference room is selected based on criteria including suitable room size, equipment availability, and proximity to the one or more visitors' location within the premises.

16. The system as claimed in claim 12, wherein the information regarding the one or more primary hosts used for querying the access database is an email ID associated with the one or more primary hosts.

17. The system as claimed in claim 12, wherein the selection module is further configured to select the one or more secondary hosts based on the predefined criteria including previous interactions with the one or more primary hosts and/or the one or more visitors and hierarchy of the one or more secondary hosts in a department of the one or more primary hosts.

18. The system as claimed in claim 12, wherein the ML model is configured to automatically allocate the one or more primary hosts based on historical data and further configured to update the allocation of the one or more primary hosts' preferences based on patterns of host availability and visitor interactions.

19. The system as claimed in claim 12, wherein the visitor management system integrates with an access control system to track real-time location of the one or more primary hosts and the one or more secondary hosts within the premises.

20. A non-transitory computer-readable medium having stored thereon computer-readable instructions that, when executed by a processor, cause the processor to execute a method for automatically allocating one or more hosts for one or more visitors, comprising the steps of:
receiving, at a visitor management system, a registration input from the one or more visitors;
querying an access database to retrieve information regarding one or more primary hosts associated with the one or more visitors;
based on the retrieved host information, determining the presence of the one or more primary hosts within a premises by retrieving an access log of the one or more primary hosts;
selecting one or more secondary hosts based on predefined criteria, if the one or more primary hosts are not present in the premises determined by the access log;
notifying the presence of the one or more visitors to the selected one or more secondary hosts;
storing an identification of the selected one or more secondary hosts; and
training a machine learning (ML) model using the registration input, the retrieved primary host information, and the stored secondary hosts' identification.
